(19) United States
(12) Patent Application Publication
(10) Pub. No.: US 2010/0111653 A1
(43) Pub. Date: May 6, 2010

(54) VERTICAL LIFT WITH SYNCHRONIZER

(75) Inventor: Mark R. Webster, Hubertus, WI (US)

Correspondence Address: MICHAEL BEST & FRIEDRICH LLP, 100 E WISCONSIN AVENUE, Suite 3300, MILWAUKEE, WI, 53202, US

(73) Assignee: PFLOW INDUSTRIES, INC., Milwaukee, WI (US)

(21) Appl. No.: 12/265,798

(22) Filed: Nov. 6, 2008

(51) Int. Cl. B65G 1/06

(52) U.S. Cl. 414/331.14; 414/630

(57) ABSTRACT

A vertical lift including a support, a carriage that is mounted for vertical movement relative to the support, a drive system including an actuator that is coupled directly to the carriage, and a synchronizer that is coupled between the carriage and the support

### BACKGROUND

The present invention relates to vertical lifts and/or conveyors.

Vertical lifts are employed in warehouses, factories and the like to convey material or cargo between different vertical levels. The typical vertical lift includes a supporting structure and a carriage, which is adapted to support cargo and is guided for vertical movement on the supporting structure.

In one type of vertical lift, as shown in U.S. Pat. No. 5,205,379, the carriage is straddled between two vertical columns of the support structure and is guided for vertical movement on the columns. The lifting of the carriage is accomplished through the use of two hydraulic cylinder units, each of which is mounted on one of the vertical columns. A piston rod of each cylinder unit is, in turn, connected to a wire rope or roller chain, having one end connected to the carriage and the other end dead headed. The piston rod of each unit carries either a sheave adapted for wire rope or a sprocket adapted for roller chain. As the cylinder rod retracts, it pulls on either the roller chain or wire rope causing the carriage to elevate from the lower to the upper level.

In another example, as shown in U.S. Pat. No. 5,908,088, a lift uses a pair of hydraulic cylinder units to elevate the carriage between levels. The cylinders are attached to each other and disposed so that one piston rod pushes downward and one piston rod pushes upward against the carriage structure.

### SUMMARY

Existing lifts that utilize hydraulic cylinder units to raise and lower the carriage are often routed in a single hydraulic circuit such that when the valves are open the hydraulic pressure in all the hydraulic cylinder units is equal. If the payload is shifted off center toward one of the cylinders, the carriage will lag on the light side until the carriage guide rollers contact the vertical guide surfaces (there is running clearance between the rollers and the guide surfaces). The moment caused by the offset load is taken up by the rollers so that each cylinder carries the same load.

The present invention provides a synchronizer system that may be used with ram-drive hydraulic cylinders that push directly on the carriage, or another drive system. The use of ram-drive hydraulic cylinders eliminates the need for broken chain safeties (e.g., safety cams) and the synchronizer system allows for one single cylinder to maintain the carriage in a substantially level position should the other cylinder fail. In previous lifts, such a cylinder failure would allow the side of the carriage with the failed cylinder to drop significantly and cause damage to the lift guide structure and carriage structure.

In one aspect, the invention provides a vertical lift that includes a support, a carriage that is mounted for vertical movement relative to the support, a drive system that includes an actuator (e.g., a hydraulic actuator) that is coupled directly to the carriage, and a synchronizer (e.g., separate from the drive system) that is coupled between the carriage and the support. In one embodiment, the synchronizer is a cross shaft that reduces the carriage tilting and reduces the load on the guide rollers. This system maintains the carriage in a substantially level condition under all loading conditions, or under failure of one cylinder.

Preferably, the synchronizer includes a first engagement member (e.g., a tensioned chain) that is attached to the support and a second engagement member (e.g., a sprocket) that is attached to the carriage and is meshed with the first engagement member.

Other aspects of the invention will become apparent by consideration of the detailed description and accompanying drawings.

### BRIEF DESCRIPTION OF THE DRAWINGS

FIG. 1 is a perspective view of a vertical lift embodying the present invention.

FIG. 2 is a partial perspective view of the vertical lift of FIG. 1.

FIG. 3 is a perspective view showing a portion of the vertical lift of FIG. 1.

FIG. 4 is a perspective view showing a portion of the vertical lift of FIG. 1.

FIG. 5 is a perspective view showing a portion of another vertical lift that is another embodiment of the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

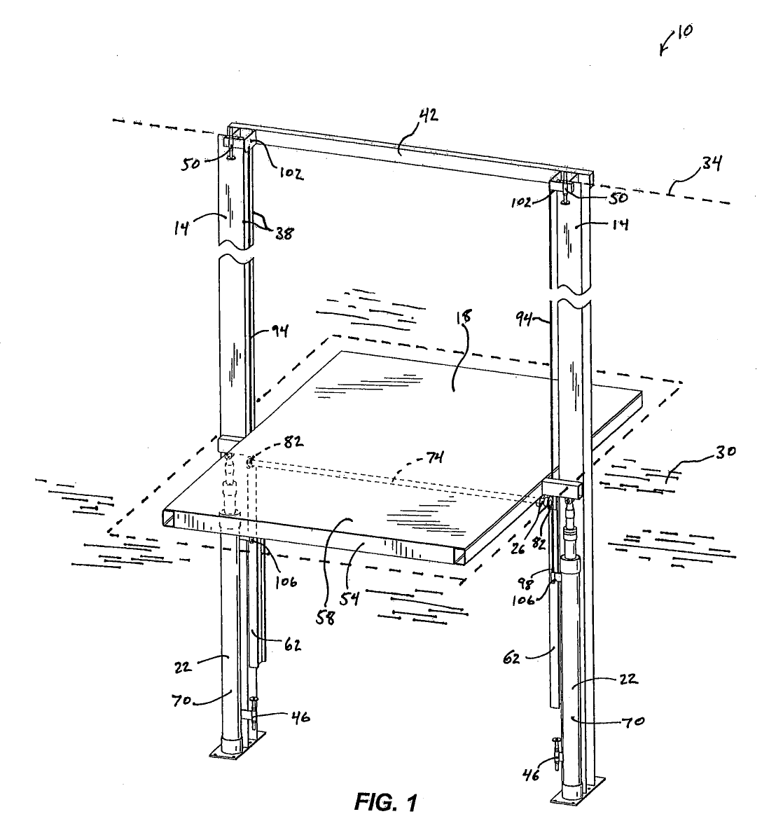

FIG. 1 shows a vertical lift 10 that includes two vertical supports 14, a carriage 18, a drive system 22, and a synchronizer assembly 26. The two vertical supports 14 extend at least between a first level 30 and a second level 34 and support the carriage 18 for movement between the first level 30 and the second level 34. The illustrated vertical supports 14 are constructed of steel and include guides 38 that engage the carriage 18 and provide added support such that the carriage 18 maintains a desired alignment with the vertical supports 14. A cross beam 42 connects the vertical supports 14 to add rigidity to the vertical supports 14. The vertical supports 14 also include a lower stop 46 and an upper stop 50. The lower and upper stops 46, 50 inhibit the carriage 18 from traveling beyond the first and second levels 30, 34, respectively. In other embodiments, the support structure may be different and may include additional truss work, cross supports, more or less than two vertical supports 14, or other support structures, as desired. In addition, the vertical supports 14 may be built into walls or another structure such as a building, a warehouse, or a quarry. Furthermore, although two vertical supports 14 are shown, more or less than two vertical supports 14 may be utilized, as desired.

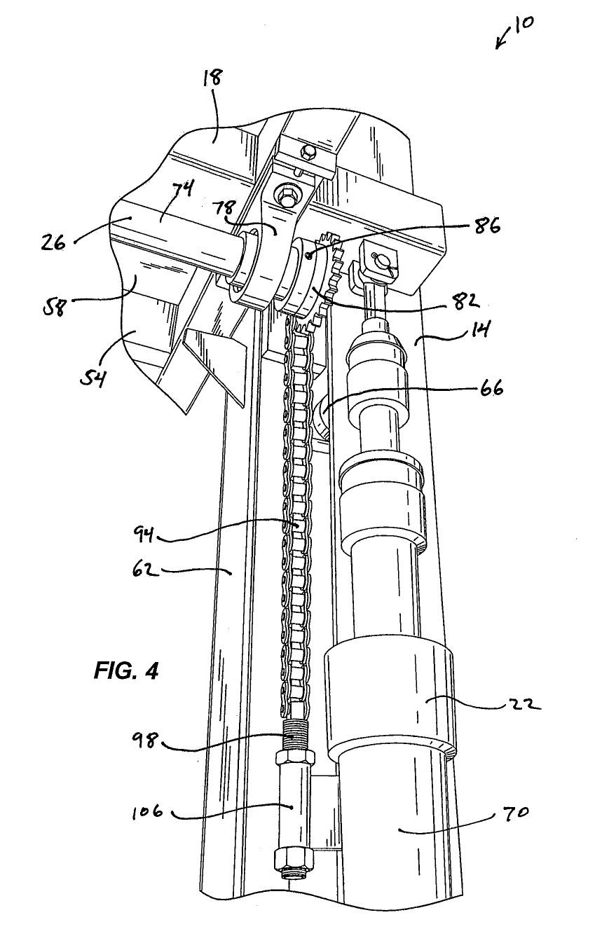

The carriage 18 includes a frame 54 and a platform 58. The frame 54 includes guide beams 62 that engage the guides 38 of the vertical supports 14 to maintain the carriage 18 in the desired alignment with respect to the vertical supports 14. The illustrated guide beams 62 have rollers 66 (see FIG. 4) that engage the guides 38 and reduce the friction between the carriage 18 and the vertical supports 14 while the carriage 18 is moving between the first level 30 and the second level 34 relative to the vertical supports 14. The platform 58 supports goods that may be moved between the first level 30 and the second level 34. In other embodiments, the carriage 18 may include guard rails, truss work, or other supports, as desired. In addition, while the illustrated carriage 18 is straddled by the two vertical supports 14, the carriage 18 could be a cantilevered carriage 18 or have another arrangement, as desired.

The drive system 22 includes two actuators in the form of hydraulic actuators 70 that are directly connected to the frame 54 of the carriage 18 and push the carriage 18 from the first level 30 to the second level 34. The illustrated hydraulic actuators 70 are telescoping actuators. If the vertical lift 10 looses power, the carriage 18 is inhibited from moving by the hydraulic fluid trapped in the hydraulic actuators 70. In other embodiments, the hydraulic actuators 70 may be sized differently to move the carriage 18 between more than two levels. In addition, any desired number of hydraulic actuators 70 may be used.

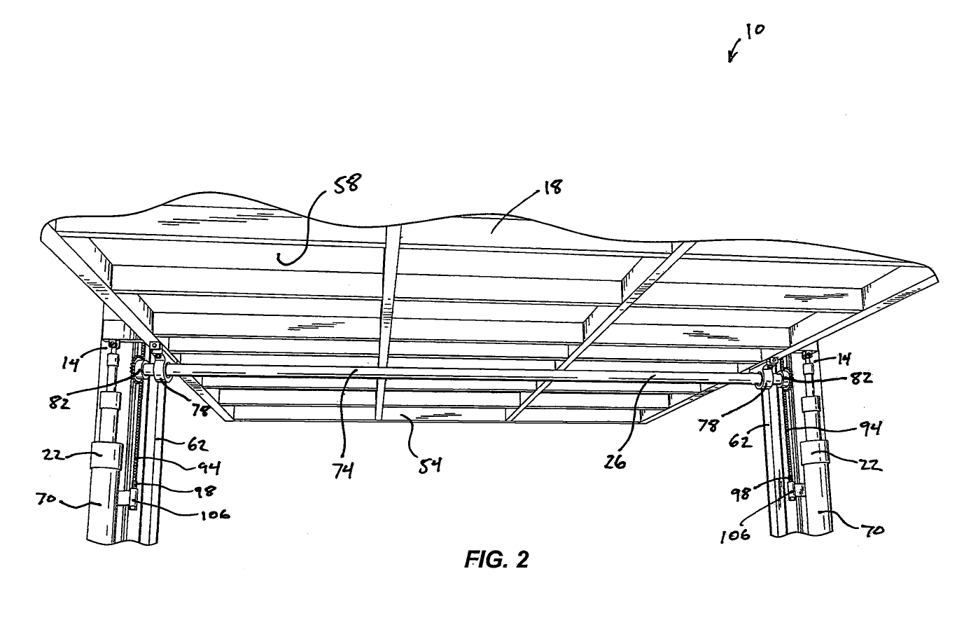

With reference to FIG. 2, the illustrated synchronizer assembly 26 is separate from the drive system 22 (i.e., the synchronizer assembly 26 does not move the carriage 18) and includes a rotary shaft 74 coupled to the frame 54 of the carriage 18 by bearings (not shown) held within a bearing housing 78 such that the rotary shaft 74 is coupled to the carriage 18 and movable therewith. The synchronizer assembly 26 is substantially the same on the right and the left. Therefore, only the right side (as viewed in FIG. 2) will be described in detail.

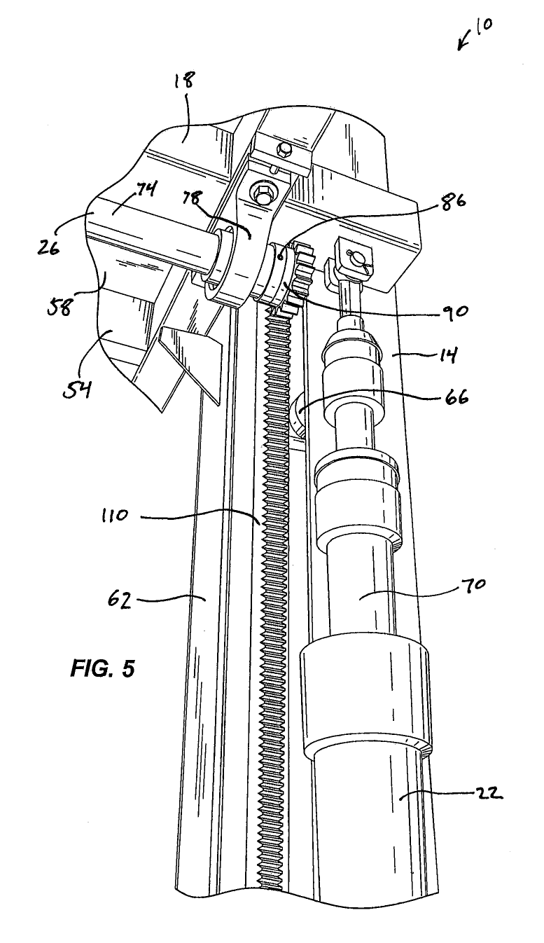

With reference to FIG. 4, a sprocket 82 is connected to the end of the rotary shaft 74 and held in rotational alignment with the rotary shaft 74 by a keyway (not shown) and a set-screw 86. The sprocket 82 is one embodiment of a toothed rotary engagement member. Other toothed rotary engagement members may be utilized, such as a gear 90 (see FIG. 5). In addition, other engagement members exist and may be used, as desired. Furthermore, the keyway (not shown) may be another form of alignment arrangement (e.g., a spine, a pin) or the engagement member may be fixed to the rotary shaft 74 with welds or in another way, as desired.

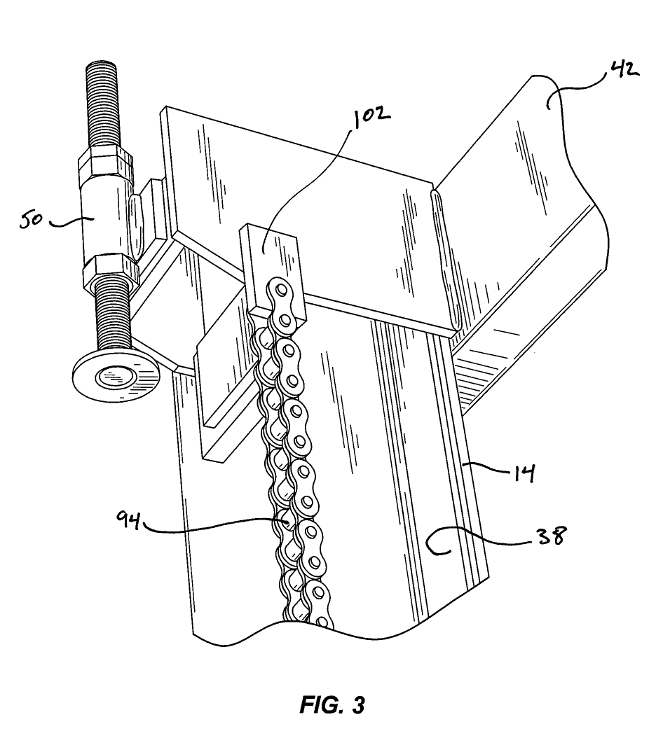

The sprocket 82 engages a chain 94 that is mounted to the vertical support 14. The chain 94 includes multiple links, a tensioner bolt 98, and a hard mount 102 welded to the vertical support 14 adjacent the upper stop 50 (see FIG. 3). The illustrated tensioner bolt 98 is threaded and threads into a tensioner mount 106 that is welded to the vertical support 14. Rotating the tensioner bolt 98 relative to the tensioner mount 106 adjusts the tension of the chain 94. The chain 94 is one embodiment of a toothed longitudinal member. Other toothed longitudinal members may be utilized, such as a toothed rack 110 (see FIG. 5). The toothed rack 110 may be used with the gear 90 to achieve a substantially similar result as that shown in FIG. 4. In other embodiments, different engagement members may be used (e.g., indexed belts and pulleys), as desired.

The two sprockets 82 are secured to the rotary shaft 74 in spaced relation to one another and each engage the respective chain 94. In this way the right and left sides of the carriage 18 are synchronized such that the carriage 18 moves between the first and second levels 30, 34 smoothly while maintaining the platform 58 substantially level. In other words, the synchronizer assembly 26 causes the two hydraulic actuators 70 to move the carriage 18 at substantially the same rate and maintain the carriage 18 in substantially the same position relative to the vertical supports 14 at any given time.

In operation, the carriage 18 is positioned at the first level 30 with the guide beams 62 contacting the lower stops 46 and the hydraulic actuators 70 fully lowered. Then, a load is positioned on the platform 58 and the carriage 18 is raised to the second level 34 by the hydraulic actuators 70. While moving from the first level 30 to the second level 34, the sprockets 82 rotate synchronously up the chains 94, thereby maintaining the two hydraulic actuators 70 in substantially the same position and moving at substantially the same speed.

When the carriage 18 reaches the second level 34, the load is removed from the platform 58. Then, the hydraulic actuators 70 move the carriage 18 from the second level 34 back to the first level 30 where a new load may be positioned on the platform 58. Alternatively, the load may be moved from the second level 34 to the first level 30. While the carriage 18 is moving from the second level 34 to the first level 30, the sprockets 82 rotate down the chain 94, thereby maintaining the two hydraulic actuators 70 in substantially the same position and moving at substantially the same speed. In other embodiments, the vertical lift 10 may travel between more than two levels.

Various features and advantages of the invention are set forth in the following claims.

What is claimed is:

1. A vertical lift comprising:
a support;
a carriage mounted for vertical movement relative to the support;
a drive system comprising an actuator coupled directly to the carriage; and
a synchronizer coupled between the carriage and the support.

2. A vertical lift as claimed in claim 1, wherein the actuator comprises a hydraulic actuator.

3. A vertical lift as claimed in claim 1, wherein the synchronizer is separate from the drive system.

4. A vertical lift as claimed in claim 1, wherein the synchronizer comprises:
a first engagement member attached to the support; and
a second engagement member attached to the carriage and meshed with the first engagement member.

5. A vertical lift as claimed in claim 4, wherein the first and second engagement members comprise toothed members.

6. A vertical lift as claimed in claim 4, wherein one engagement member comprises a rotary member and the other engagement member comprises a longitudinal member.

7. A vertical lift as claimed in claim 6, wherein the rotary member comprises a gear and the longitudinal member comprises a toothed rack.

8. A vertical lift as claimed in claim 6, wherein the rotary member comprises a sprocket and the longitudinal member comprises a chain.

9. A vertical lift as claimed in claim 6, wherein the rotary member is mounted on and movable with the carriage, and wherein the longitudinal member is coupled to the support.

10. A vertical lift as claimed in claim 4, wherein one of the engagement members comprises a rotational shaft having two rotary members secured in spaced relation to each other, and the other of the engagement members comprises two longitudinal members, each aligned with and engaging a corresponding rotary member.

11. A vertical lift as claimed in claim 10, wherein the rotational shaft is mounted on and movable with the carriage, and wherein the longitudinal members are coupled to the support.

12. A vertical lift comprising:
a support;
a carriage mounted for vertical movement relative to the support;
a drive system comprising an actuator coupled to the carriage; and
a synchronizer coupled between the carriage and the support and separate from the drive system, the synchronizer comprising:
a first engagement member attached to the support; and
a second engagement member attached to the carriage and being meshed with the first engagement member.

13. A vertical lift as claimed in claim 12, wherein the first and second engagement members comprise toothed members.

14. A vertical lift as claimed in claim 12, wherein one engagement member comprises a rotary member and the other engagement member comprises a longitudinal member.

15. A vertical lift as claimed in claim 14, wherein the rotary member comprises a gear and the longitudinal member comprises a toothed rack.

16. A vertical lift as claimed in claim 14, wherein the rotary member comprises a sprocket and the longitudinal member comprises a chain.

17. A vertical lift as claimed in claim 14, wherein the rotary member is mounted on and movable with the carriage, and wherein the longitudinal member is coupled to the support.

18. A vertical lift as claimed in claim 12, wherein one of the engagement members comprises a rotational shaft having two rotary members secured in spaced relation to each other, and the other of the engagement members comprises two longitudinal members, each aligned with and engaging a corresponding rotary member.

19. A vertical lift as claimed in claim 18, wherein the rotational shaft is mounted on and movable with the carriage, and wherein the longitudinal members are coupled to the support.
